(19) United States
(12) Patent Application Publication
(10) Pub. No.: US 2025/0142502 A1
(43) Pub. Date: May 1, 2025

(54) SYSTEMS AND METHOD FOR BIDIRECTIONAL TIMING MEASUREMENT

(71) Applicant: Telefonaktiebolaget LM Ericsson (publ), Stockholm (SE)

(72) Inventor: Muhammad Ali Kazmi, Sundbyberg (SE)

(21) Appl. No.: 18/683,999

(22) PCT Filed: Aug. 17, 2022
(86) PCT No.: PCT/IB2022/057721

§ 371 Date: Feb. 15, 2024

Related U.S. Application Data
(60) Provisional application No. 63/234,141, filed on Aug. 17, 2021.

(51) Int. Cl. H04W 56/00

(52) U.S. Cl. CPC H04W 56/0045; H04W 56/001

(57) ABSTRACT

Systems and methods of bidirectional timing measurement are provided. In some embodiments, a method performed by a User Equipment (UE) includes: receiving a configuration for performing a bidirectional timing measurement on one or more cells; adapting the bidirectional timing measurement procedure based on one or more conditions or relations or criteria; and using the adapted procedure for performing the configured bidirectional timing measurement. The bidirectional timing measurement can be a UE Receive-Transmit (Rx-Tx) time difference. The measurement adaption can include: whether the cell for the bidirectional timing measurement is the Downlink reference cell for a Sounding Reference Signal (SRS) for the UE. In this way, the bidirectional timing measurement performance is enhanced. The UE only discards bidirectional timing measurement (e.g., UE Rx-Tx time difference) when the UE autonomous timing adjustment will make the measurement inaccurate. The positioning measurement accuracy determined based on the multi-RTT measurement is improved.

### RELATED APPLICATIONS

This application claims the benefit of U.S. Provisional Patent Application No. 63/234,141, filed Aug. 17, 2021, the disclosure of which is hereby incorporated herein by reference in its entirety.

### TECHNICAL FIELD

The disclosure relates generally to timing measurement.

### BACKGROUND

New Radio (NR) architecture is illustrated in FIG. 1, where gNB and ng-eNB (or evolved eNB) denote NR Base Stations (BSs) (one NR BS may correspond to one or more transmission/reception points, TRPs), and the lines between the nodes illustrate the corresponding interfaces.

Location management function (LMF) is the location node or positioning server in NR. There are also interactions between the location node and the gNB via the NR positioning protocol annex (NRPPa) (not illustrated in FIG. 1) and between a User Equipment (UE) and the location server via a Long Term Evolution (LTE) positioning protocol (LPP), which is also used in NR. The interactions between the gNB and the UE are supported via the Radio Resource Control (RRC) protocol. Note 1: The gNB and ng-eNB may not always both be present. Note 2: When both the gNB and ng-eNB are present, the NG-C interface is only present for one of them.

### Timing Measurements

A timing measurement, which can be performed by the UE or by a network node (e.g., BS), can be unidirectional or it can be bidirectional. A first node (Node1) herein refers to a node performing a timing measurement. Node1 can be a UE or a network node. Unidirectional timing measurement is performed by Node1 for measuring transmit timing (Tx) of signal transmitted by Node1 or is used for measuring reception timing (Rx) of signal received by Node1 from a second node (Node2). Bidirectional timing measurement is performed by Node1 for measuring relation between the transmit timing (Tx) of signal transmitted by Node1 and the reception timing (Rx) of signal received at Node1 from Node2. An example of the relation is the difference between the transmission and the reception timings. In the timing measurements in one example, Node1 may measure the absolute reception timing of the signal, and/or it may measure reception timing of the signal with regard to a reference time. Similarly, in one example, Node1 may measure the absolute transmit timing of the signal and/or it may measure transmit timing of the signal with respect to a reference time.

In NR, the timing measurements are used for different purposes e.g.,
Estimation of the timing advance e.g., by base station.
Propagation delay compensation for Ultra Reliable Low Latency Communication (URLLC) e.g., by UE, base station.
UE timing measurements for positioning e.g., UE Rx-Tx time difference, multi-RTT etc.
gNB timing measurements for positioning e.g., gNB Rx-Tx time difference, Uplink (UL) Relative Time of Arrival (RTOA) etc.

In NR several timing measurements for positioning are specified. An example of bidirectional timing measurement is round trip time (RTT). Specific examples of bidirectional timing measurement are UE Rx-Tx time difference, gNB Rx-Tx time difference, time advance (TA) etc.

The UE Rx-Tx time difference is defined as T_{UE-RX}−T_{UE-TX}

### Where:

T_{UE-RX} is the UE received timing of downlink subframe # i from a positioning node, defined by the first detected path in time. It is measured on Positioning Reference Signals (PRSs) received from the gNB.
T_{UE-TX} is the UE transmit timing of uplink subframe # j that is closest in time to the subframe # i received from the positioning node. It is measured on Sounding Reference Signals (SRSs) transmitted by the UE.

The gNB Rx-Tx time difference is defined as T_{gNB-RX}−T_{gNB-TX}

### Where:

T_{gNB-RX} is the positioning node received timing of uplink subframe # i containing SRS associated with UE, defined by the first detected path in time. It is measured on SRS signals received from the UE.
T_{gNB-TX} is the positioning node transmit timing of downlink subframe # j that is closest in time to the subframe # i received from the UE. It is measured on PRS signals transmitted by gNB.

Other examples of bidirectional measurements are eNB measurements such as Timing Advance Type 1 and Timing Advance Type 2, as were specified in LTE.

An example of unidirectional timing measurement is UL Relative Time of Arrival (UL RTOA). It is defined as the beginning of subframe i containing SRS received in positioning node j, relative to the configurable reference time. For example, Node1 (e.g., base station etc.) measures the reception time of signals transmitted by the UE with respect to a reference time.

### Reference Signals for NR RTT Positioning Measurements

### Positioning Reference Signals

Positioning reference signals (PRSs) are periodically transmitted on a positioning frequency layer in PRS resources in the Downlink (DL) by the gNB. The information about the PRS resources is signaled to the UE by the positioning node via higher layers but may also be provided by base station, e.g., via broadcast. Each positioning frequency layer comprises PRS resource sets, where each PRS resource set comprises one or more PRS resources. All the DL PRS resources within one PRS resource set are configured with the same periodicity. The PRS resource periodicity (Tₚₑᵣ^{PRS}) comprises:

Tₚₑᵣ^{PRS}2^{μ}{4, 8, 16, 32, 64, 5, 10, 20, 40, 80, 160, 320, 640, 1280, 2560, 5120, 10240, 20480} slots, where μ=0, 1, 2, 3 for PRS SCS of 15, 30, 60 and 120 kHz respectively. Tₚₑᵣ^{PRS}=2^{μ}·20480 is not supported for μ=0.

Each PRS resource can also be repeated within one PRS resource set and takes values Tᵣₑₚ^{PRS}∈{1, 2, 4, 6, 8, 16, 32}.

PRSs are transmitted in a consecutive number of symbols (L_{PRS}) within a slot: L_{PRS}∈{2, 4, 6, 12}. The following DL PRS Resource Element (RE) patterns, with comb size K_{PRS} equal to number of symbols L_{PRS} are supported
Comb-2: Symbols {0, 1} have relative RE offsets {0, 1}
Comb-4: Symbols {0, 1, 2, 3} have relative RE offsets {0, 2, 1, 3}
Comb-6: Symbols {0, 1, 2, 3, 4, 5} have relative RE offsets {0, 3, 1, 4, 2, 5}.
Comb-12: Symbols {0, 1, 2, 3, 4, 5, 6, 7, 8, 9, 10, 11} have relative RE offsets {0,6,3,9,1,7,4, 10,2,8,5,11}

Maximum PRS BW is 272 PRBs. Minimum PRS BW is 24 PRBs. The configured PRS BW is always a multiple of 4.

### Sounding Reference Signals

For positioning timing measurements (e.g., UE Rx-Tx, gNB, Rx-Tx, UL RTOA etc.), the UE is configured with SRS for uplink transmission. The SRS comprises one or more SRS resource set and each SRS resource set comprising one or more SRS resources. Each SRS resource comprises one or more symbols carrying SRS with certain SRS bandwidth. There can be periodic SRS, aperiodic SRS, and semi-persistent SRS transmissions—any of them can also be used for positioning measurements. There are two options for SRS configuration for positioning:

In one example, the UE can be configured with an SRS resource set where each SRS resource occupies N_{S}∈{1,2,4} adjacent symbols within a slot. In this case, SRS antenna switching is supported. Each symbol can also be repeated with repetition factor R∈{1,2,4}, where R≤Nₛ. The periodic SRS resource can be configured with certain periodicity (T_{Srs}) e.g.

T_{SRS}∈{1, 2, 4, 5, 8, 10, 16, 20, 32, 40, 64, 80, 160, 320, 640, 1280, 2560} slots.

In another example, the UE can be configured with an SRS positioning specific resource set (SRS-PosResourceSet). In this case, each SRS positioning resource (SRS-PosResource) occupies N_{S}∈{1,2,4,8,12} adjacent symbols within a slot. In this case, SRS antenna switching is not supported.

In both options, the UE can be configured with 1, 2, or 4 antenna ports for transmitting each SRS resource within SRS resource set. The default value is one SRS antenna port for each SRS resource

There currently exist certain challenge(s). In NR, the UE starts uplink transmission in radio frame number i (N_{TA}+N_{TA offset})×T_{c} seconds before the start of the corresponding downlink radio frame i at the UE, where 1 Tc≈0.51 ns (basic time unit in NR, specified in TS 38.211 v16.6.0). This is shown in FIG. 2. The N_{TA} depends on the timing advance (TA) command sent to the UE by the base station. The TA adjustment step size depends on the subcarrier spacing (SCS) of the uplink signal. N_{TA} is therefore a variable time offset which relates UL and DL frame timings. The UE is also configured with N_{TA offset} which depends on the duplex mode of the cell in which the uplink transmission takes place and the frequency range (FR) as shown in table 1, e.g., N_{TA offset}=0, 25600 Tc (13 μs) and 39936 Tc (20 μs) in frequency range #1 (FR1) and 13792 Tc (7 μs) in frequency range #2 (FR2). N_{TA offset} is therefore a fixed time offset relating the UL and DL frame timings.

The UE also follows the downlink frame timing change of a reference cell. Examples of reference cells are serving cells of the UE such as SpCell, SCell, etc. Examples of SpCell are PCell, PSCell, etc. The UE transmit timing adjustment based on the change in the timing of the DL reference cell is also called as UE autonomous timing adjustment or UE autonomous timing change etc.

The UE uses the received timing of a reference signal (e.g., Synchronization Signal Block (SSB)) transmitted by the reference cell for determining the change of the DL frame timing of the reference cell. The UE may typically monitor the reference cell for changes in the DL frame timing once every T0 period e.g., T0=160 ms. The UE autonomous timing adjustment is done in the same direction in which the DL frame timing change of the reference cell changes. For example, if the DL frame timing change of the reference cell advances by a certain amount (e.g., δt1) compared to a certain reference timing value (Tr), then the UE also advances its transmit timing by the same amount or by a similar amount or by a proportional amount (e.g., k1*δt1). In one example, k1=1. But if the DL frame timing change of the reference cell recedes or lags by certain amount (e.g., δt2), then the UE also recedes its transmit timing by the same amount or by a similar amount or by a proportional amount (e.g., k2*δt2). In one example k2=1. Examples of the reference timing value (Tr) are:

In one example, Tr is the DL frame timing of the reference cell before the latest change in the DL frame timing determined by the UE.

In another example, Tr is the UL transmit timing before the latest change in the DL frame timing determined by the UE.

In another example, Tr is the DL frame timing of the reference cell determined by the UE in a previous occasion e.g., at time k3*T0 period before the current timing of the UE. In one example K3=1.

The UE autonomous timing adjustment is further described with examples. Assume that the UE current transmit timing when the UE determines the change in DL frame timing of the reference cell is T2.

In one example if the DL frame timing, as determined by the UE, advances by k1*δt1, then the UE new timing (T3) after applying the autonomous adjustment will be T3=T2+k1*δt1. In another example, if the DL frame timing as determined by the UE recedes or lags by k2*δt2, then the UE new timing (T3) after applying the autonomous adjustment will be T3=T2-k2*δt2.

In NR, the UE can be configured to perform multi-RTT measurements on multiple cells. The multi-RTT measurement is a type of bi-directional timing measurement. Improved systems and methods of bi-directional timing measurement are needed.

### SUMMARY

Systems and methods of bi-directional timing measurement are provided. In some embodiments, a method performed by a User Equipment (UE) for bidirectional timing measurement includes: receiving a configuration for performing a bidirectional timing measurement on one or more cells; adapting the bidirectional timing measurement procedure based on one or more conditions or relations or criteria; and using the adapted procedure for performing the configured bidirectional timing measurement.

In some embodiments, the bidirectional timing measurement is a UE Receive-Transmit (Rx-Tx) time difference. In some embodiments, the conditions or relations or criteria triggering the measurement adaption include: whether the cell for the bidirectional timing measurement is the Downlink (DL) reference cell for Sounding Reference Signal (SRS) for the UE.

Certain embodiments may provide one or more of the following technical advantages. The bidirectional timing measurement performance is enhanced. The UE only discards bidirectional timing measurement (e.g., UE Rx-Tx time difference) when the UE autonomous timing adjustment will make the measurement inaccurate. The positioning measurement accuracy determined based on the multi-RTT measurement is improved.

In some embodiments, a method performed by a network node for bi-directional timing measurement includes: configuring a UE with a bidirectional timing measurement on one or more cells; receiving one or more bidirectional timing measurements; where the bidirectional timing measurement procedure was adapted based on one or more conditions or relations or criteria.

In some embodiments, the conditions or relations or criteria triggering the measurement adaption comprise one or more of: whether or not, both Uplink (UL) Reference Signal (RS) and DL RS configured for performing the bidirectional timing measurement operate in a UE's DL reference cell; and whether the uplink transmission timing changes during the bidirectional timing measurement period due to UE autonomous timing adjustment.

In some embodiments, if both UL RS and DL RS configured for performing the bidirectional timing measurement operate in the UE's DL reference cell, then the UE performs or continues performing the bidirectional timing measurement regardless of whether the UE's uplink transmission timing changes during the bidirectional timing measurement period due to the UE autonomous timing adjustment.

In some embodiments, if both UL RS and DL RS configured for performing the bidirectional timing measurement do not operate in the UE's DL reference cell, then whether the UE performs or continues performing the bidirectional timing measurement depends on whether the UE's uplink transmission timing changes during the bidirectional timing measurement period due to the UE autonomous timing adjustment.

In some embodiments, the UL RS comprises SRS and the DL RS comprises Positioning Reference Signal (PRS).

In some embodiments, if the uplink transmission timing changes during the bidirectional timing measurement period due to UE autonomous timing adjustment, discarding, stopping, abandoning, or postponing the bidirectional timing measurement.

In some embodiments, the method also includes discarding, stopping, abandoning, or postponing the bidirectional timing measurement being performed or configured to be performed in a cell in which the SRS is not configured if the uplink transmission timing changes during the bidirectional timing measurement period due to UE autonomous timing adjustment.

In some embodiments, the method also includes performing or continuing performing the bidirectional timing measurement in a cell in which the SRS is configured regardless of whether the uplink transmission timing changes during the bidirectional timing measurement period due to UE autonomous timing adjustment.

In some embodiments, the bidirectional timing measurement requirement for the bidirectional timing measurement performed in a cell in which the SRS is not configured shall not apply if the uplink transmission timing changes during the UE Rx-Tx time difference measurement period due to UE autonomous timing adjustment.

In some embodiments, bidirectional timing measurement requirement for the bidirectional timing measurement performed in a cell in which the SRS is configured shall apply regardless of whether the uplink transmission timing changes during the UE Rx-Tx time difference measurement period due to UE autonomous timing adjustment.

In some embodiments, if the uplink transmission timing changes during the bidirectional timing measurement period due to UE autonomous timing adjustment, the measurement is restarted.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates a New Radio (NR) architecture, where gNB and ng-eNB (or evolved eNB) denote NR Base Stations (BSs) (one NR BS may correspond to one or more transmission/reception points, TRPs), and the lines between the nodes illustrate the corresponding interfaces;

FIG. 2 illustrates an example where the User Equipment (UE) starts uplink transmission in radio frame number i (N_{TA}+N_{TA offset})×T_{c} seconds before the start of the corresponding downlink radio frame i at the UE, where 1 Tc ≈0.51 ns;

FIG. 3 illustrates a method performed by a UE for bidirectional timing measurement, according to some embodiments of the current disclosure;

FIG. 4 illustrates a method performed by a network node for enabling bidirectional timing measurement, according to some embodiments of the current disclosure;

FIGS. 5A, 5B, and 5C illustrate examples where the Network Node 2 (NN2) may be configured to perform bi-directional timing measurement on signals operating between the UE and NN2, according to some embodiments of the current disclosure;

FIG. 6 shows an example of a communication system in accordance with some embodiments;

FIG. 7 shows a UE in accordance with some embodiments;

FIG. 8 shows a network node in accordance with some embodiments;

FIG. 9 is a block diagram of a host, which may be an embodiment of the host of FIG. 6;

FIG. 10 is a block diagram illustrating a virtualization environment in which functions implemented by some embodiments may be virtualized; and

FIG. 11 shows a communication diagram of a host communicating via a network node with a UE over a partially wireless connection in accordance with some embodiments.

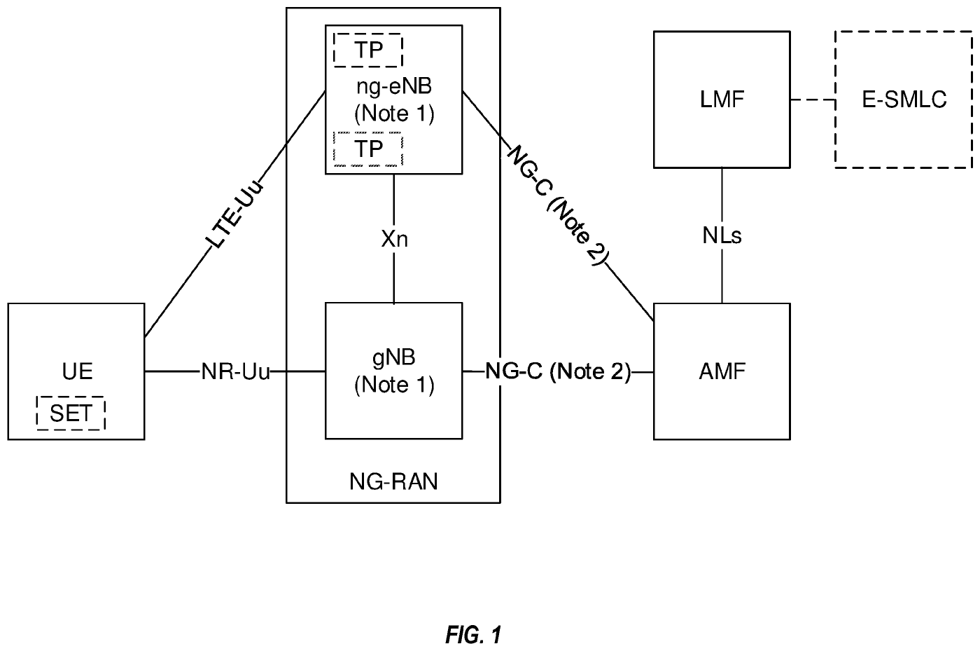

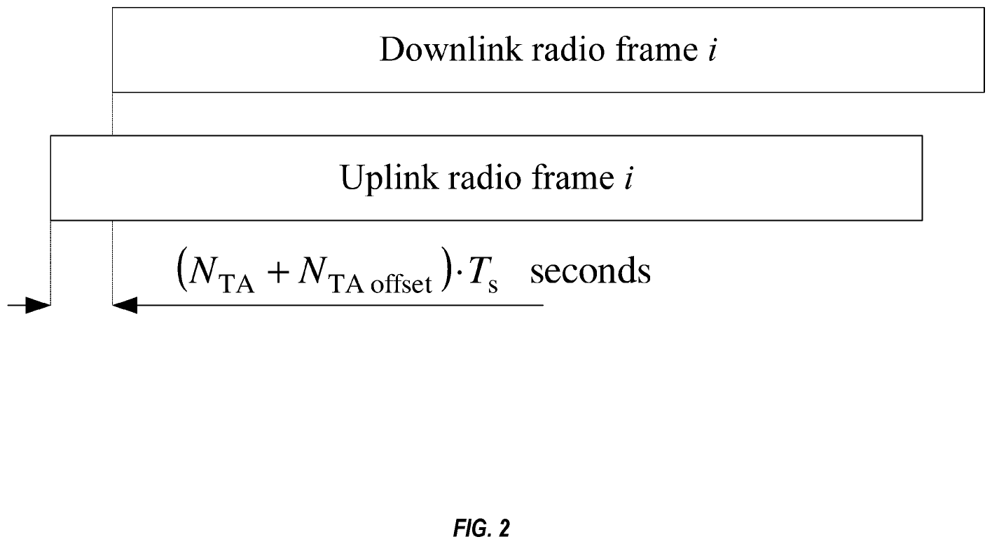

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

In this invention disclosure a term node is used which can be a network node or a user equipment (UE).

Examples of network nodes are NodeB, base station (BS), multi-standard radio (MSR) radio node such as MSR BS, eNodeB, gNodeB. MeNB, SeNB, location measurement unit (LMU), integrated access backhaul (IAB) node, network controller, radio network controller (RNC), base station controller (BSC), relay, donor node controlling relay, base transceiver station (BTS), Central Unit (e.g., in a gNB), Distributed Unit (e.g., in a gNB), Baseband Unit, Centralized Baseband, Centralized Radio Access Network (C-RAN), access point (AP), transmission points, transmission nodes, transmission reception point (TRP), RRU, RRH, nodes in distributed antenna system (DAS), core network node (e.g., MSC, MME etc.), O&M, OSS, SON, positioning node (e.g., E-SMLC), etc.

The non-limiting term UE refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, PDA, tablet, mobile terminals, smart phone, laptop embedded equipment (LEE), laptop mounted equipment (LME), USB dongles etc.

The term radio access technology, or RAT, may refer to any RAT e.g., UTRA, E-UTRA, narrow band internet of things (NB-IoT), WiFi, Bluetooth, next generation RAT, New Radio (NR), 4G, 5G, etc. Any of the equipment denoted by the term node, network node or radio network node may be capable of supporting a single or multiple RATs.

The term signal or radio signal used herein can be any physical signal or physical channel. Examples of DL physical signals are reference signal such as PSS, SSS, CSI-RS, DMRS, signals in SSB, DRS, CRS, PRS etc. Examples of UL physical signals are reference signal such as SRS, DMRS etc. The term physical channel refers to any channel carrying higher layer information e.g., data, control etc. Examples of physical channels are PBCH, NPBCH, PDCCH, PDSCH, sPUCCH, SPDSCH. sPUCCH. sPUSCH, MPDCCH, NPDCCH, NPDSCH, E-PDCCH, PUSCH, PUCCH, NPUSCH, etc.

The term time resource used herein may correspond to any type of physical resource or radio resource expressed in terms of length of time. Examples of time resources are: symbol, time slot, subframe, radio frame, TTI, interleaving time, slot, sub-slot, mini-slot, etc.

A round trip time (RTT) measurement performed by a first node (Node1) is a relation between two timing measurement components: a first component comprising measuring reception timing (T_{RX}) of a signal received by Node1 from a second node (Node2) and a second component comprising measuring transmission timing (T_{TX}) of a signal transmitted by Node1. An example of the relation is the difference between T_{RX} and T_{TX} (e.g., T_{RX}−T_{TX}). RTT is also called as a bidirectional timing measurement. Examples of RTT measurements are UE RX-TX time difference measurement, network node or gNB RX-TX time difference measurement, timing advance, propagation delay etc.

The term multi-round trip (multi-RTT) measurement used herein corresponds to any UE measurement comprising at least one RTT measurement on signals of one serving cell or TRP (e.g., PCell, PSCell, etc.) and at least one RTT measurement on signals of another cell or TRP (e.g., a neighbor cell, another serving cell etc.). Examples of multi-RTT measurements are multi-RTT positioning measurements such as multiple UE RX-TX time difference measurements involving two or more cells, timing advance, combination of or difference between two RTT measurements, etc.

In NR, the UE can be configured to perform multi-RTT measurements on multiple cells. The multi-RTT measurement is a type of bidirectional timing measurement. The multi-RTT measurements are bidirectional timing measurements on two or more cells. Typically, one of the cells is also a DL reference cell of the UE and is used by the UE for a UE autonomous timing adjustment. The impact of the UE timing adjustment on multi-RTT measurements on different cells is therefore different and depends on whether the UE autonomous timing adjustment has any relation to DL reception time in the cell where the measurement is performed. Therefore, the UE autonomous timing adjustment may or may not impact the accuracy of the multi-RTT measurement. It is therefore inefficient to perform the multi-RTT measurements on all the cells using the same measurement procedures with regard to the UE autonomous timing adjustment procedure. Improved systems and methods of bidirectional timing measurement are needed.

Systems and methods of bidirectional timing measurement are provided. In some embodiments, a method performed by a User Equipment (UE) for bidirectional timing measurement includes: receiving a configuration for performing a bidirectional timing measurement on one or more cells; adapting the bidirectional timing measurement procedure based on one or more conditions or relations or criteria; and using the adapted procedure for performing the configured bidirectional timing measurement.

In some embodiments, the bidirectional timing measurement is a UE Receive-Transmit (Rx-Tx) time difference. In some embodiments, the conditions or relations or criteria triggering the measurement adaption include: whether the cell for the bidirectional timing measurement is the Downlink (DL) reference cell for Sounding Reference Signal (SRS) for the UE.

Certain embodiments may provide one or more of the following technical advantages. The bidirectional timing measurement performance is enhanced. The UE only discards bidirectional timing measurement (e.g., UE Rx-Tx time difference) when the UE autonomous timing adjustment will make the measurement inaccurate. The positioning measurement accuracy determined based on the multi-RTT measurement is improved.

Certain aspects of the disclosure and their embodiments may provide solutions to these or other challenges. The invention comprises of method in a UE and a network node (e.g., BS, LMU etc.).

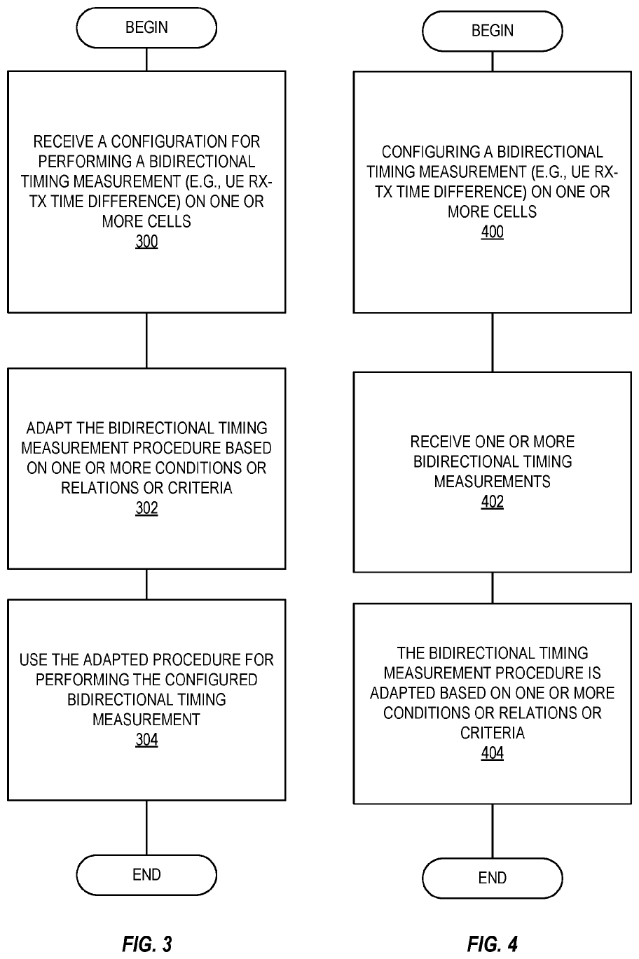

FIG. 3 illustrates a method performed by a user equipment, the method includes one or more of: receiving a configuration for performing a bidirectional timing measurement (e.g., UE Rx-Tx time difference) on one or more cells (step 300); adapting the bidirectional timing measurement procedure based on one or more conditions or relations or criteria (step 302); and using the adapted procedure for performing the configured bidirectional timing measurement (step 304).

FIG. 4 illustrates a method performed by a network node, the method includes one or more of: configuring a UE for performing a bidirectional timing measurement (e.g., gNB Rx-Tx time difference) on one or more cells (step 400); receiving one or more bidirectional timing measurements (step 402); where the bidirectional timing measurement procedure was adapted based on one or more conditions or relations or criteria (step 404).

According to a first embodiment which comprises a method in a UE, the UE configured with a bidirectional timing measurement (e.g., UE Rx-Tx time difference) on one or more cells adapts the bidirectional timing measurement procedure based on one or more conditions or relations or criteria and uses the adapted procedure for performing the configured bidirectional timing measurement. The conditions or relations or criteria triggering the measurement adaption are:

Whether or not both UL Reference Signals (RSs) (e.g., SRS) and DL RS (e.g., PRS) configured for performing the bidirectional timing measurement operate (e.g., transmit and/or receive) in a UE's DL reference cell, which in turn is used for UE autonomous timing adjustment,

Whether the uplink transmission timing changes during the bidirectional timing measurement period due to UE autonomous timing adjustment.

In one example of the measurement adaptation which can be defined as rule for defining UE behavior, if both the UL RS (e.g., SRS) and the DL RS (e.g., PRS) configured for performing the bidirectional timing measurement operate in the UE's DL reference cell, then the UE performs or continues performing the bidirectional timing measurement regardless of whether the UE's uplink transmission timing changes during the bidirectional timing measurement period due to the UE autonomous timing adjustment.

If both the UL RS (e.g., SRS) and the DL RS (e.g., PRS) configured for performing the bidirectional timing measurement do not operate in the UE's DL reference cell, then whether the UE performs or continues performing the bidirectional timing measurement depends on whether the UE's uplink transmission timing changes during the bidirectional timing measurement period due to the UE autonomous timing adjustment. For example, in this case (if both UL and DL RSs are not in DL reference cell), if the uplink transmission timing changes during the bidirectional timing measurement period due to UE autonomous timing adjustment, then the UE discards, stops, abandons or postpones the bidirectional timing measurement, Otherwise the UE performs or continues performing the bidirectional timing measurement (i.e., if the uplink transmission timing does not change during the bidirectional timing measurement period due to UE autonomous timing adjustment).

In another example of the measurement adaptation, the UE discards or stops or abandons or postpones the bidirectional timing measurement (e.g., UE Rx-Tx time difference measurement) being performed or configured to be performed in a cell in which the SRS is not configured if the uplink transmission timing changes during the bidirectional timing measurement period (e.g., UE Rx-Tx time difference measurement period) due to UE autonomous timing adjustment. But if the uplink transmission timing does not during the bidirectional timing measurement period due to UE autonomous timing adjustment, then the UE performs or continues performing the bidirectional timing measurement in the cell in which the SRS is not configured.

The UE performs or continues performing the bidirectional timing measurement (e.g., UE Rx-Tx time difference measurement) in a cell in which the SRS is configured regardless of whether the uplink transmission timing changes during the bidirectional timing measurement period (e.g., UE Rx-Tx time difference measurement period) due to UE autonomous timing adjustment.

In another example of the measurement adaptation, which can be defined in terms of requirements, the bidirectional timing measurement requirement (e.g., UE Rx-Tx time difference measurement accuracy requirements) for the bidirectional timing measurement performed in a cell in which the SRS is not configured shall not apply if the uplink transmission timing changes during the UE Rx-Tx time difference measurement period due to the UE autonomous timing adjustment.

The bidirectional timing measurement requirement (e.g., UE Rx-Tx time difference measurement accuracy requirements) for the bidirectional timing measurement performed in a cell in which the SRS is configured shall apply regardless of whether the uplink transmission timing changes during the UE Rx-Tx time difference measurement period due to the UE autonomous timing adjustment.

According to a second embodiment which comprises a method in a network node (NN), the NN configured with a bidirectional timing measurement (e.g., gNB Rx-Tx time difference) on one or more cells, adapts the bidirectional timing measurement procedure based on one or more conditions or relations or criteria and uses the adapted procedure for performing the configured bidirectional timing measurement. The conditions and criteria are the same as described for the UE in the first embodiment.

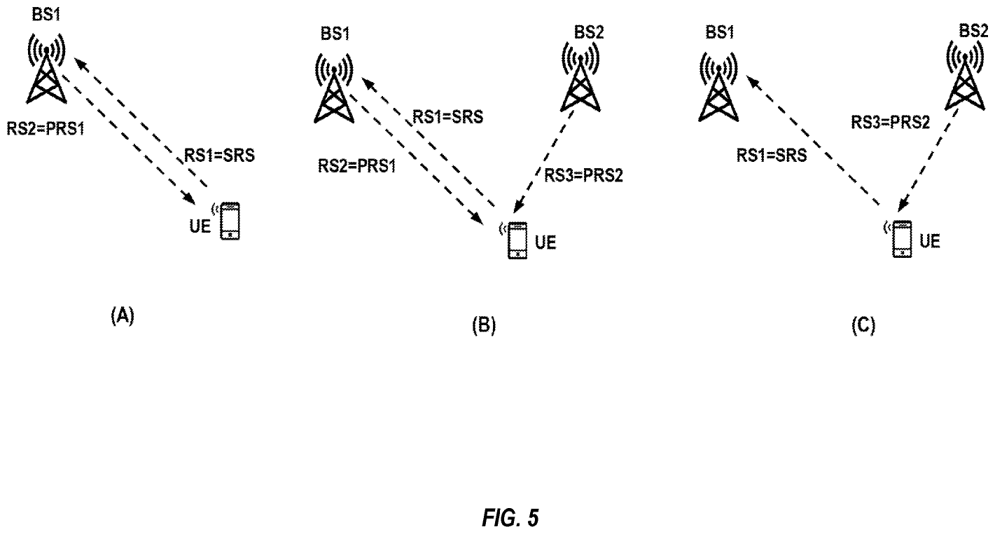

The scenario comprises at least a UE and at least two radio network nodes (e.g., BS, LMU etc.). The UE transmits a first reference signal (RS1) in a first cell (cell1) served or managed by a first network node (NN1). The UE may also be served by NN1 e.g., serving cell (cell1) of the UE. In one example, cell1 may be the UE's special cell (SpCell) e.g., primary cell (PCell) or primary secondary cell (PSCell). The UE is configured with both PCell and PSCell in dual connectivity (DC). In DC, the UE may also be configured with one or more SCells. The UE is configured with PCell and one or more SCells in carrier aggregation. In another example, cell1 may be UE's SCell. NN1 may be configured to transmit a second reference signal (RS2). A second network node (NN2) may also be configured to transmit a third reference signal (RS3). NN2 may operate or serve or manage a second cell (cell2). In one example, cell2 may be another serving cell of the UE e.g., SCell, SpCell etc. In another example, cell2 may be a non-serving cell of the UE e.g., neighbor cell etc. The cells cell1 and cell may operate on the same carrier frequency or on different carrier frequencies. The carrier frequency may also be called a frequency layer, layer, positioning frequency layer etc. The UE may further be configured to receive RS2 from NN1 and RS3) from NN2. The RSs, RS1, RS2 and RS3 are used by the UE and/or by the network node (e.g., NN1, NN2 etc.) for performing one or more bidirectional timing measurements. The UE or the network node may be configured by another node (e.g., another BS, positioning node etc.) to perform bi-directional timing measurements on signals operating between the UE and one or more network nodes. The term operating a signal between nodes comprising one node transmitting the signal to another node and/or one node receiving the signals from another node. Examples of signals are reference signals, pilot signals etc. Examples of reference signals are PRS, SRS, DMRS, SSB, CSI-RS etc. For example, the UE may be configured to perform bidirectional timing measurement on signals operating between the UE and NN1, or between the UE and NN2 or between (UE and NN1), and (the UE and NN2). In another example, the NN1 may be configured to perform bi-directional timing measurement on signals operating between the UE and NN1. In another example the NN2 may be configured to perform bi-directional timing measurement on signals operating between the UE and NN2. An example is shown in FIGS. 5A-C as explained below.

In the example shown in FIG. 5A, the UE is configured to perform a first UE bidirectional timing measurement (e.g., a first UE round trip time (UE-RTT1)) using RS1 and RS2. The UE measures the transmit timing (Tx) of RS1 and reception timing (Rx) of RS2 to determine the UE-RTT1 e.g., the difference between Rx and Tx. An example of UE-RTT1 is UE Rx-Tx time difference measurement. In this example, the NN1 may also be configured to perform a first network node bidirectional timing measurement (e.g., a first NN round trip time (NN1-RTT1)) using RS1 and RS2. NN1 measures the transmit timing (Tx) of RS2 and reception timing (Rx) of RS1 to determine the NN1-RTT1 e.g., the difference between Rx and Tx. An example of NN1-RTT1 is gNB Rx-Tx time difference measurement.

In the example shown in FIG. 5B, the UE is configured to perform UE-RTT1 as well as a second UE bidirectional timing measurement (e.g., a second UE round trip time (UE-RTT2)) using RS1 and RS3. The UE measures the transmit timing (Tx) of RS1 and reception timing (Rx) of RS3 to determine the UE-RTT2 e.g., the difference between Rx and Tx. An example of UE-RRT2 is also UE Rx-Tx time difference measurement. In this example, the NN2 may also be configured to perform a second network node bidirectional timing measurement (e.g., a second NN round trip time (NN2-RTT2)) using RS1 and RS3. NN2 measures the transmit timing (Tx) of RS3 and reception timing (Rx) of RS1 to determine the NN2-RTT2 e.g., the difference between Rx and Tx. An example of NN2-RTT2 is also gNB Rx-Tx time difference measurement.

In the example shown in FIG. 5C, the UE is configured to perform UE-RTT2 and not configured to perform UE-RTT1. In this example the NN2 may also be NN2-RRT2.

The UE performs RTT measurements involving multiple nodes (e.g., NN1, NN2, etc.) which are also called multi-RTT measurements or multiple-RTT measurements. The corresponding measurement procedure may be called a multiple-RTT measurement procedure. The embodiments are applicable for UE performing multiple-RTT measurements involving any number of nodes.

The UE may further be configured to autonomously adjust its uplink transmit timing based on the DL timing (e.g., frame timing) of a reference cell. In this scenario, it is assumed that cell1 is the reference cell of the UE. For example, the UE may use the received timing of a reference signal (e.g., SSB, CSI-RS etc.) transmitted by the reference cell for determining the change of the DL frame timing of the reference cell. The UE may typically monitor the reference cell for change in the DL frame timing once every TO period e.g., T0=160 ms. The UE autonomous timing adjustment is done in the same direction in which the DL frame timing change of the reference cell changes. For example, if the DL frame timing change of the reference cell advances by certain amount (e.g., δt1) compared to certain reference timing value (Tr), then the UE also advances its transmit timing by the same amount or by a similar amount or by a proportional amount (e.g., k1*δt1). In one example, k1=1. But if the DL frame timing change of the reference cell recedes or lags by certain amount (e.g., δt2) then the UE also recedes its transmit timing by the same amount or by a similar amount or by a proportional amount (e.g., k2*δt2). In one example, k2=1. Examples of the reference timing value (Tr) are:

In one example, Tr is the DL frame timing of the reference cell before the latest change in the DL frame timing determined by the UE. In another example, Tr is the UL transmit timing before the latest change in the DL frame timing determined by the UE. In another example, Tr is the DL frame timing of the reference cell determined by the UE in a previous occasion, e.g., at a time k3*T0 period before the current timing of the UE. In one example, K3=1.

The UE autonomous timing adjustment is further described with examples. Assume that the UE current transmit timing when the UE determines the change in DL frame timing of the reference cell is T2. In one example, if the DL frame timing as determined by the UE, advances by k1*δt1, then the UE new timing (T3) after applying the autonomous adjustment will be T3=T2+k1*δt1. In another example, if the DL frame timing as determined by the UE recedes or lags by k2*δt2, then the UE new timing (T3) after applying the autonomous adjustment will be T3=T2−k2*δt2.

The base station receiver may not receive the UE transmitted signal if there is a large, abrupt change in the UE autonomous timing adjustment. Therefore, if one or more conditions is met or triggered, then the UE may adapt the UE autonomous timing adjustment step size and/or total or aggregated amount of UE autonomous timing adjustment in a certain period (Ta). The adaptation prevents sudden and large changes in the UE transmit timing, enabling the base station to efficiently receive the UE signal. For example, when the transmission timing error between the UE and the reference timing exceeds a threshold (e.g., ±Tₑ), then the UE is required to adjust its timing to within ±Tₑ. All adjustments made to the UE uplink timing follow these rules:

The maximum amount of the magnitude of timing change in one adjustment is within limit e.g., T_{q}. The minimum aggregated adjustment rate is Tₚ per second. The maximum aggregate adjustment rate is T_{q} per 200 ms.

Method in UE of adapting bidirectional timing measurement procedure. According to a first embodiment, a UE configured to performed bidirectional timing measurements on one or more cells determines whether a cell in which reception timing (Rx) and transmit timing (Tx) used for estimating or obtaining a bidirectional timing measurement is also measured in a reference cell of the UE for the UE autonomous timing adjustment, and based on this determination, the UE adapts the UE bidirectional timing measurement procedure. The adaptation of the measurement procedure may further depend on whether the uplink transmission timing changes or not during the bidirectional timing measurement period due to UE autonomous timing adjustment. For example, if the cells in which reception timing (Rx) and transmit timing (Tx) used for estimating or obtaining the bidirectional timing measurement, are measured, in also the reference cell of the UE for the UE autonomous timing adjustment, then the UE further determines whether the uplink transmission timing changes or not during the bidirectional timing measurement period due to UE autonomous timing adjustment, and based on that adapt the measurement procedure.

The reference cell for UE autonomous timing adjustment, the cells for bidirectional timing measurements, and reference signals (e.g., DL RS, UL RS, etc.) for bidirectional timing measurements, may change over time e.g., based on one or more of modification or change or updates of assistance data and/or measurement configurations, cell change (e.g., handover etc.).

The method of adaptation of the bidirectional timing measurement procedure in the UE can be defined in terms of one or more rules. For example, the adaptation may comprise performing the bidirectional timing measurement or continue performing the bidirectional timing measurement or discarding or stopping or postponing or restarting the bidirectional timing measurement. The rules can be pre-defined or configured by the network node. The rules define the UE behavior. This is explained with several examples below.

In one example, if both Rx and Tx parts of bidirectional timing measurement are measured in a cell (e.g., cell1) which is also the reference cell of the UE, then the UE performs or continues performing the bidirectional timing measurement regardless of whether the uplink transmission timing changes or not during the bidirectional timing measurement period due to UE autonomous timing adjustment.

Otherwise, if the uplink transmission timing changes during the bidirectional timing measurement period due to UE autonomous timing adjustment, the UE does not perform the bidirectional timing measurement. For example, in the latter case, the UE may perform one or more of: does not perform, stop performing, discard, abandon, restart or postpone the bidirectional timing measurement. For example, the UE may restart the measurement after the UE autonomous timing adjustment. After a certain number (Na) of autonomous timing adjustments, the UE may stop the measurement and may further discard the measurement results.

In another example, if both Rx and Tx parts of bidirectional timing measurement are measured in a cell (e.g., cell1) which is also the reference cell of the UE then the UE performs or continues performing the bidirectional timing measurement regardless of whether the uplink transmission timing changes or not during the bidirectional timing measurement period due to the UE autonomous timing adjustment.

If Rx and Tx parts of bidirectional timing measurement are measured in the reference cell (e.g., cell1) and non-reference cell (e.g., cell2) respectively, then the UE performs or continues performing the bidirectional timing measurement regardless of whether the uplink transmission timing changes or not during the bidirectional timing measurement period due to the UE autonomous timing adjustment.

If none of the Rx and Tx parts of bidirectional timing measurement are measured in the reference cell (e.g., cell1), then the UE performs or continues performing the bidirectional timing measurement regardless of whether the uplink transmission timing changes or not during the bidirectional timing measurement period due to the UE autonomous timing adjustment.

Otherwise, if Rx and Tx parts of bidirectional timing measurement are measured in the non-reference cell (e.g., cell2) and reference cell respectively, and if the uplink transmission timing changes during the bidirectional timing measurement period due to UE autonomous timing adjustment, then the UE may perform one or more of: does not perform, stop performing, discard, abandon, restart or postpone, the bidirectional timing measurement.

In another example, if DL RS (e.g., PRS) is measured for Rx part of the bidirectional timing measurement in the same cell (e.g., cell1) where UL RS (e.g., SRS) is transmitted or configured for Tx part of that bidirectional timing measurement then the UE performs or continues performing the bidirectional timing measurement regardless of whether the uplink transmission timing changes or not during the bidirectional timing measurement period due to the UE autonomous timing adjustment.

Otherwise, if the DL RS is measured for Rx part of the bidirectional timing measurement in a cell (e.g., cell2) different than a cell where UL RS (e.g., SRS) is transmitted or configured for Tx part of that bidirectional timing measurement, and if the uplink transmission timing changes during the bidirectional timing measurement period due to UE autonomous timing adjustment then the UE does not perform, stop performing, discard, abandon, restart or postpone the bidirectional timing measurement.

In another example, if the UE is configured with DL RS (e.g., PRS) and UL RS (e.g., SRS) for performing the bidirectional timing measurement in the same cell (e.g., cell1) then the UE performs or continues performing the bidirectional timing measurement regardless of whether the uplink transmission timing changes or not during the bidirectional timing measurement period due to the UE autonomous timing adjustment.

Otherwise, if the UE is configured with the DL RS (e.g., PRS) and the UL RS (e.g., SRS) for performing the bidirectional timing measurement in different cells (e.g., DL RS in cell2 and UL RS in cell1, or DL RS in cell1 and UL RS in cell2, or DL RS and UL RS in cell2) and if the uplink transmission timing changes during the bidirectional timing measurement period due to the UE autonomous timing adjustment, then the UE does not perform, stop performing, discard, abandon, restart or postpone the bidirectional timing measurement.

In another example, if the UE is configured with DL RS (e.g., PRS) and UL RS (e.g., SRS) for performing the bidirectional timing measurement in a serving cell (e.g., cell1), then the UE performs or continues performing the bidirectional timing measurement regardless of whether the uplink transmission timing changes or not during the bidirectional timing measurement period due to the UE autonomous timing adjustment.

Otherwise, if the UE is configured with at least one of the DL RS (e.g., PRS) and UL RS (e.g., SRS) for performing the bidirectional timing measurement in a non-serving cell (e.g., both DL RS and UL RS in cell2, which is non-serving) and if the uplink transmission timing changes during the bidirectional timing measurement period due to UE autonomous timing adjustment, then the UE does not perform, stop performing, discard, abandon, restart or postpone the bidirectional timing measurement.

In another example, if the UE is configured to perform the bidirectional timing measurement in the same cell (e.g., cell1) where UL RS (e.g., SRS) is configured or transmitted for the bidirectional timing measurement (e.g., cell1) then the UE performs or continues performing the bidirectional timing measurement regardless of whether the uplink transmission timing changes or not during the bidirectional timing measurement period due to UE autonomous timing adjustment.

Otherwise, if the UE is configured to perform the bidirectional timing measurement in a cell (e.g., cell2) different than a cell where UL RS (e.g., SRS) is configured or transmitted for the bidirectional timing measurement (e.g., cell1) and if the uplink transmission timing changes during the bidirectional timing measurement period due to UE autonomous timing adjustment, then the UE does not perform, stop performing, discard, abandon, restart or postpone the bidirectional timing measurement.

In another example, the UE does not perform, stop performing, discards, abandons, restarts or postpones, the bidirectional timing measurement in a cell in which the UL RS for bidirectional timing measurement is not configured, if the uplink transmission timing changes during the bidirectional timing measurement period due to UE autonomous timing adjustment. Otherwise, the UE performs or continues performing the measurement if the uplink transmission timing does not change during the bidirectional timing measurement period due to the UE autonomous timing adjustment.

In one specific example the above rule can be expressed as: the UE does not perform, stop performing, discards, abandons, restarts or postpones, the UE Rx-Tx time difference measurement in a cell in which the SRS is not configured, if the uplink transmission timing changes during the UE Rx-Tx time difference measurement period due to UE autonomous timing adjustment. Otherwise, the UE performs or continues performing the measurement if the uplink transmission timing does not change during the bidirectional timing measurement period due to the UE autonomous timing adjustment.

In another example, the UE performs or continues performing the bidirectional timing measurement in a cell if the UL RS for bidirectional timing measurement is configured in that cell, regardless of whether the uplink transmission timing changes or not during the bidirectional timing measurement period due to the UE autonomous timing adjustment.

In one specific example, the above rule can be expressed as: The UE performs or continues performing the UE Rx-Tx time difference in a cell in which the SRS is configured regardless of whether the uplink transmission timing changes or not during the UE Rx-Tx time difference measurement period due to the UE autonomous timing adjustment.

The rules may also be expressed or defined in terms of one or more UE requirements. The requirements may be pre-defined or configured by the network node. Examples of requirements are measurement time over which the measurement is performed (e.g., UE Rx-Tx time difference measurement period), measurement accuracy (e.g., UE Rx-Tx time difference measurement accuracy within ±X1 Tc; where 1 Tc≈0.5 ns), etc. If the UE performs the bidirectional timing measurement, then the UE meets the one or more requirement, otherwise (e.g., if UE discards, stops or does not perform the measurement) then the UE is not required to meet one or more requirements. The rules in terms of requirements are explained with several examples below.

In one example, if both Rx and Tx parts of the bidirectional timing measurement are measured in a cell (e.g., cell1), which is also the reference cell of the UE, then the UE meets one or more requirements related to the bidirectional timing measurement (e.g., meets UE Rx-Tx time difference measurement accuracy, UE Rx-Tx time difference measurement period etc.), regardless of whether the uplink transmission timing changes or not during the bidirectional timing measurement period due to UE autonomous timing adjustment;

Otherwise, and if the uplink transmission timing changes during the bidirectional timing measurement period due to UE autonomous timing adjustment, then the UE does not meet or is not expected or is not required to meet one or more requirements related to the bidirectional timing measurement.

In another example, if both Rx and Tx parts of the bidirectional timing measurement are measured in a cell (e.g., cell1), which is also the reference cell of the UE, then the UE meets one or more requirements related to the bidirectional timing measurement, regardless of whether the uplink transmission timing changes or not during the bidirectional timing measurement period due to the UE autonomous timing adjustment.

If Rx and Tx parts of bidirectional timing measurement are measured in the reference cell (e.g., cell1) and non-reference cell (e.g., cell2) respectively, then the UE meets one or more requirements related to the bidirectional timing measurement, regardless of whether the uplink transmission timing changes or not during the bidirectional timing measurement period due to the UE autonomous timing adjustment.

If none of the Rx and Tx parts of bidirectional timing measurement are measured in the reference cell (e.g., cell1), then the UE meets one or more requirements related to the bidirectional timing measurement, regardless of whether the uplink transmission timing changes or not during the bidirectional timing measurement period due to the UE autonomous timing adjustment.

Otherwise, if Rx and Tx parts of bidirectional timing measurement are measured in the non-reference cell (e.g., cell2) and reference cell respectively, and if the uplink transmission timing changes during the bidirectional timing measurement period due to UE autonomous timing adjustment, then the UE does not meet or is not expected or is not required to meet one or more requirements related to the bidirectional timing measurement.

In another example, if the DL RS (e.g., PRS) is measured for Rx part of the bidirectional timing measurement in the same cell (e.g., cell1) where UL RS (e.g., SRS) is transmitted or configured for Tx part of that bidirectional timing measurement, then the UE meets one or more requirements related to the bidirectional timing measurement, regardless of whether the uplink transmission timing changes or not during the bidirectional timing measurement period due to the UE autonomous timing adjustment.

Otherwise, if the DL RS is measured for Rx part of the bidirectional timing measurement in a cell (e.g., cell2) different than a cell where UL RS (e.g., SRS) is transmitted or configured for Tx part of that bidirectional timing measurement then the UE does not meet or is not expected or is not required to meet one or more requirements related to the bidirectional timing measurement.

In another example, if the UE is configured with the DL RS (e.g., PRS) and the UL RS (e.g., SRS) for performing the bidirectional timing measurement in the same cell (e.g., cell1) then the UE meets one or more requirements related to the bidirectional timing measurement, regardless of whether the uplink transmission timing changes or not during the bidirectional timing measurement period due to the UE autonomous timing adjustment.

Otherwise, if the UE is configured with the DL RS (e.g., PRS) and the UL RS (e.g., SRS) for performing the bidirectional timing measurement in different cells (e.g., DL RS in cell2 and UL RS in cell1, or DL RS in cell1 and UL RS in cell2, or DL RS and UL RS in cell2) and if the uplink transmission timing changes during the bidirectional timing measurement period due to the UE autonomous timing adjustment, then the UE does not meet or is not expected or is not required to meet one or more requirements related to the bidirectional timing measurement.

In another example, if the UE is configured with the DL RS (e.g., PRS) and the UL RS (e.g., SRS) for performing the bidirectional timing measurement in a serving cell (e.g., cell1) then the UE meets one or more requirements related to the bidirectional timing measurement, regardless of whether the uplink transmission timing changes or not during the bidirectional timing measurement period due to the UE autonomous timing adjustment. Otherwise, if the UE is configured with at least one of the DL RS (e.g., PRS) and UL RS (e.g., SRS) for performing the bidirectional timing measurement in a non-serving cell (e.g., both DL RS and UL RS in cell2, which is non-serving) and if the uplink transmission timing changes during the bidirectional timing measurement period due to the UE autonomous timing adjustment, then the UE does not meet or is not expected or is not required to meet one or more requirements related to the bidirectional timing measurement.

In another example, if the UE is configured to perform the bidirectional timing measurement in the same cell (e.g., cell1) where UL RS (e.g., SRS) is configured or transmitted for the bidirectional timing measurement (e.g., cell1) then the UE meets one or more requirements related to the bidirectional timing measurement, regardless of whether the uplink transmission timing changes or not during the bidirectional timing measurement period due to the UE autonomous timing adjustment;

Otherwise, if the UE is configured to perform the bidirectional timing measurement in a cell (e.g., cell2) different than a cell where UL RS (e.g., SRS) is configured or transmitted for the bidirectional timing measurement (e.g., cell1) and if the uplink transmission timing changes during the bidirectional timing measurement period due to the UE autonomous timing adjustment, then the UE does not meet or is not expected or is not required to meet one or more requirements related to the bidirectional timing measurement.

In another example, the requirement for a bidirectional timing measurement performed in a cell in which the UL RS used for bidirectional timing measurement is not configured shall not apply if the uplink transmission timing changes during the bidirectional timing measurement period due to the UE autonomous timing. Otherwise, if the uplink transmission timing does not change during the bidirectional timing measurement period due to UE autonomous timing, then the requirement for bidirectional timing measurement shall apply.

A specific example of the above rule can be expressed as follows: UE Rx-Tx time difference measurement accuracy requirements for UE Rx-Tx measurement performed in a cell in which the SRS is not configured shall not apply if the uplink transmission timing changes during the UE Rx-Tx time difference measurement period due to the UE autonomous timing. Otherwise, if the uplink transmission timing does not change during the UE Rx-Tx time difference measurement period due to UE autonomous timing, then the requirement for bidirectional timing measurement shall apply.

In another example, the requirement for bidirectional timing measurement performed in a cell in which the UL RS used for bidirectional timing measurement is configured shall apply regardless of whether the uplink transmission timing changes or not during the bidirectional timing measurement period due to the UE autonomous timing adjustment.

A specific example of the above rule can be expressed as follows: UE Rx-Tx measurement accuracy requirements for UE Rx-Tx time difference measurement, performed in a cell in which the SRS is configured, shall apply regardless of whether the uplink transmission timing changes or not during the UE Rx-Tx time difference measurement period due to the UE autonomous timing.

In any of the above examples, the UE may further inform the network node the results of the adaptation. For example, the UE may inform the network node (e.g., positioning node such as LMF) that the UE has performed or is going to perform one or more of the following: has not or will not perform, stop performing, discards, abandons, restarts or postpones, the bidirectional timing measurement. The UE may further inform the network node the reason for the adaptation e.g., UL RS and DL RS are measured on different cells.

### Method in Network Node of Adapting Bidirectional Timing Measurement Procedure

According to a second embodiment, a network node (NN) (e.g., BS. LMU etc.), which is configured to perform bidirectional timing measurements on one or more cells, determines whether a cell in which reception timing (Rx) and transmit timing (Tx) used for estimating or obtaining a bidirectional timing measurement, are measured, in also a reference cell of the UE for the UE autonomous timing adjustment, and based on this determination the NN adapts the NN bidirectional timing measurement procedure.

The reference cell for UE autonomous timing adjustment, the cells for NN bidirectional timing measurements and reference signals (e.g., DL RS, UL RS etc.) for NN bidirectional timing measurements, may change over time e.g., based on one or more of modification or change or updates of assistance data and/or measurement configurations, cell change (e.g., handover etc.).

The method of adaptation of the bidirectional timing measurement procedure in the NN can be defined in terms of one or more rules. For example, the adaptation may comprise performing the bidirectional timing measurement or continue performing the bidirectional timing measurement or discarding or stopping or postponing or restarting the bidirectional timing measurement. The rules can be pre-defined or configured by another network node e.g., by the positioning node. The rules define the NN behavior. The examples of rules related to the UE behavior described above also apply for the NN. The rules may also be expressed or defined in terms of one or more NN requirements. The examples of rules related to the UE requirements described above also apply for the NN.

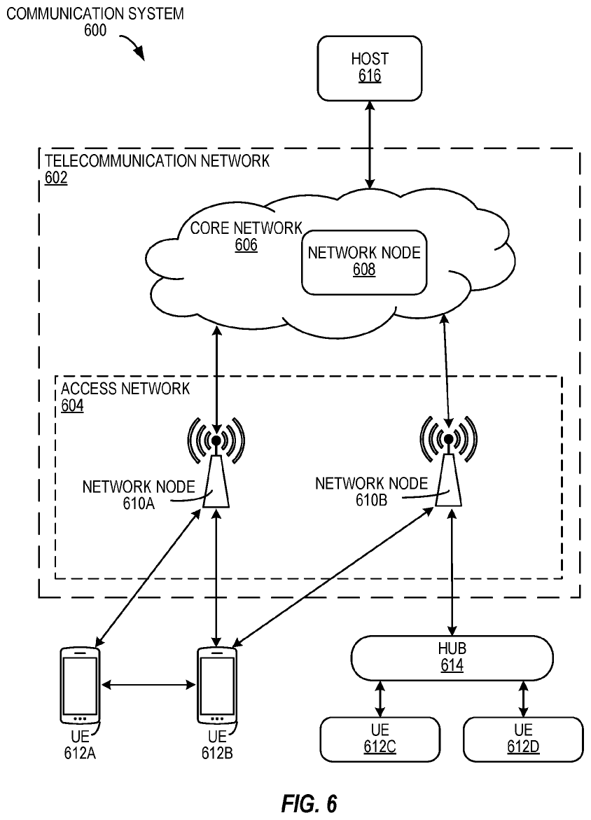

FIG. 6 shows an example of a communication system 600 in accordance with some embodiments. In the example, the communication system 600 includes a telecommunication network 602 that includes an access network 604, such as a Radio Access Network (RAN), and a core network 606, which includes one or more core network nodes 608. The access network 604 includes one or more access network nodes, such as network nodes 610A and 610B (one or more of which may be generally referred to as network nodes 610), or any other similar Third Generation Partnership Project (3GPP) access node or non-3GPP Access Point (AP). The network nodes 610 facilitate direct or indirect connection of User Equipment (UE), such as by connecting UEs 612A, 612B, 612C, and 612D (one or more of which may be generally referred to as UEs 612) to the core network 606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 600 may include any number of wired or wireless networks, network nodes, UEs, and/or any other components or systems that may facilitate or participate in the communication of data and/or signals whether via wired or wireless connections. The communication system 600 may include and/or interface with any type of communication, telecommunication, data, cellular, radio network, and/or other similar type of system.

The UEs 612 may be any of a wide variety of communication devices, including wireless devices arranged, configured, and/or operable to communicate wirelessly with the network nodes 610 and other communication devices. Similarly, the network nodes 610 are arranged, capable, configured, and/or operable to communicate directly or indirectly with the UEs 612 and/or with other network nodes or equipment in the telecommunication network 602 to enable and/or provide network access, such as wireless network access, and/or to perform other functions, such as administration in the telecommunication network 602.

In the depicted example, the core network 606 connects the network nodes 610 to one or more hosts, such as host 616. These connections may be direct or indirect via one or more intermediary networks or devices. In other examples, network nodes may be directly coupled to hosts. The core network 606 includes one more core network nodes (e.g., core network node 608) that are structured with hardware and software components. Features of these components may be substantially similar to those described with respect to the UEs, network nodes, and/or hosts, such that the descriptions thereof are generally applicable to the corresponding components of the core network node 608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 616 may be under the ownership or control of a service provider other than an operator or provider of the access network 604 and/or the telecommunication network 602, and may be operated by the service provider or on behalf of the service provider. The host 616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 600 of FIG. 6 enables connectivity between the UEs, network nodes, and hosts. In that sense, the communication system 600 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 602 is a cellular network that implements 3GPP standardized features. Accordingly, the telecommunication network 602 may support network slicing to provide different logical networks to different devices that are connected to the telecommunication network 602. For example, the telecommunication network 602 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 612 are configured to transmit and/or receive information without direct human interaction. For instance, a UE may be designed to transmit information to the access network 604 on a predetermined schedule, when triggered by an internal or external event, or in response to requests from the access network 604. Additionally, a UE may be configured for operating in single-or multi-Radio Access Technology (RAT) or multi-standard mode. For example, a UE may operate with any one or combination of WiFi, New Radio (NR), and LTE, i.e. be configured for Multi-Radio Dual Connectivity (MR-DC), such as Evolved UMTS Terrestrial RAN (E-UTRAN) NR-Dual Connectivity (EN-DC).

In the example, a hub 614 communicates with the access network 604 to facilitate indirect communication between one or more UEs (e.g., UE 612C and/or 612D) and network nodes (e.g., network node 610B). In some examples, the hub 614 may be a controller, router, content source and analytics, or any of the other communication devices described herein regarding UEs. For example, the hub 614 may be a broadband router enabling access to the core network 606 for the UEs. As another example, the hub 614 may be a controller that sends commands or instructions to one or more actuators in the UEs. Commands or instructions may be received from the UEs, network nodes 610, or by executable code, script, process, or other instructions in the hub 614. As another example, the hub 614 may be a data collector that acts as temporary storage for UE data and, in some embodiments, may perform analysis or other processing of the data. As another example, the hub 614 may be a content source. For example, for a UE that is a Virtual Reality (VR) headset, display, loudspeaker or other media delivery device, the hub 614 may retrieve VR assets, video, audio, or other media or data related to sensory information via a network node, which the hub 614 then provides to the UE either directly, after performing local processing, and/or after adding additional local content. In still another example, the hub 614 acts as a proxy server or orchestrator for the UEs, in particular in if one or more of the UEs are low energy IoT devices.

The hub 614 may have a constant/persistent or intermittent connection to the network node 610B. The hub 614 may also allow for a different communication scheme and/or schedule between the hub 614 and UEs (e.g., UE 612C and/or 612D), and between the hub 614 and the core network 606. In other examples, the hub 614 is connected to the core network 606 and/or one or more UEs via a wired connection. Moreover, the hub 614 may be configured to connect to a Machine-to-Machine (M2M) service provider over the access network 604 and/or to another UE over a direct connection. In some scenarios, UEs may establish a wireless connection with the network nodes 610 while still connected via the hub 614 via a wired or wireless connection. In some embodiments, the hub 614 may be a dedicated hub—that is, a hub whose primary function is to route communications to/from the UEs from/to the network node 610B. In other embodiments, the hub 614 may be a non-dedicated hub—that is, a device which is capable of operating to route communications between the UEs and the network node 610B, but which is additionally capable of operating as a communication start and/or end point for certain data channels.

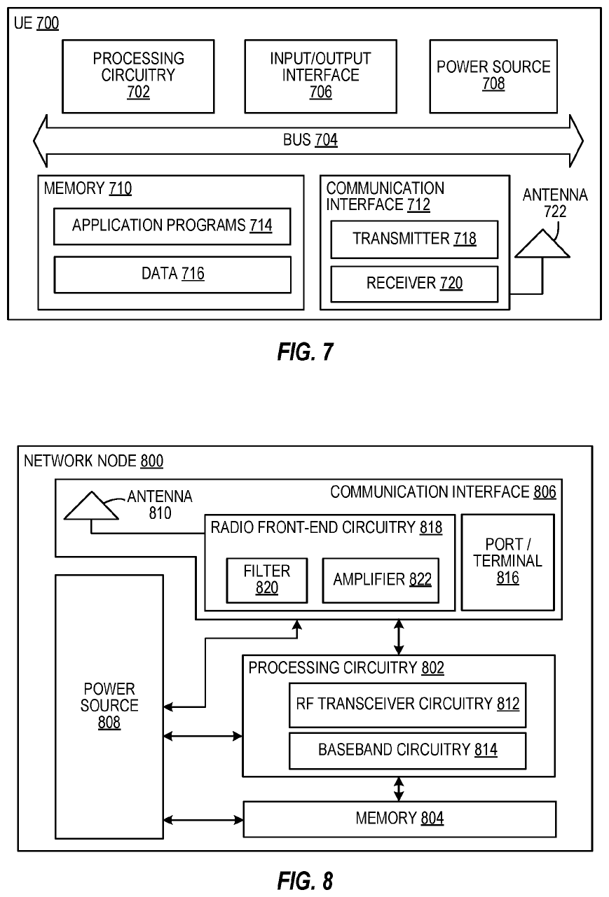

FIG. 7 shows a UE 700 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VoIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 700 includes processing circuitry 702 that is operatively coupled via a bus 704 to an input/output interface 706, a power source 708, memory 710, a communication interface 712, and/or any other component, or any combination thereof. Certain UEs may utilize all or a subset of the components shown in FIG. 7. The level of integration between the components may vary from one UE to another UE. Further, certain UEs may contain multiple instances of a component, such as multiple processors, memories, transceivers, transmitters, receivers, etc.

The processing circuitry 702 is configured to process instructions and data and may be configured to implement any sequential state machine operative to execute instructions stored as machine-readable computer programs in the memory 710. The processing circuitry 702 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 702 may include multiple Central Processing Units (CPUs).

In the example, the input/output interface 706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 708 is structured as a battery or battery pack. Other types of power sources, such as an external power source (e.g., an electricity outlet), photovoltaic device, or power cell, may be used. The power source 708 may further include power circuitry for delivering power from the power source 708 itself, and/or an external power source, to the various parts of the UE 700 via input circuitry or an interface such as an electrical power cable. Delivering power may be, for example, for charging the power source 708. Power circuitry may perform any formatting, converting, or other modification to the power from the power source 708 to make the power suitable for the respective components of the UE 700 to which power is supplied.

The memory 710 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 710 includes one or more application programs 714, such as an operating system, web browser application, a widget, gadget engine, or other application, and corresponding data 716. The memory 710 may store, for use by the UE 700, any of a variety of various operating systems or combinations of operating systems.

The memory 710 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 710 may allow the UE 700 to access instructions, application programs, and the like stored on transitory or non-transitory memory media, to off-load data, or to upload data. An article of manufacture, such as one utilizing a communication system, may be tangibly embodied as or in the memory 710, which may be or comprise a device-readable storage medium.

The processing circuitry 702 may be configured to communicate with an access network or other network using the communication interface 712. The communication interface 712 may comprise one or more communication subsystems and may include or be communicatively coupled to an antenna 722. The communication interface 712 may include one or more transceivers used to communicate, such as by communicating with one or more remote transceivers of another device capable of wireless communication (e.g., another UE or a network node in an access network). Each transceiver may include a transmitter 718 and/or a receiver 720 appropriate to provide network communications (e.g., optical, electrical, frequency allocations, and so forth). Moreover, the transmitter 718 and receiver 720 may be coupled to one or more antennas (e.g., the antenna 722) and may share circuit components, software, or firmware, or alternatively be implemented separately.

In the illustrated embodiment, communication functions of the communication interface 712 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 712, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 700 shown in FIG. 7.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 8 shows a network node 800 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 800 includes processing circuitry 802, memory 804, a communication interface 806, and a power source 808. The network node 800 may be composed of multiple physically separate components (e.g., a Node B component and an RNC component, or a BTS component and a BSC component, etc.), which may each have their own respective components. In certain scenarios in which the network node 800 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 800 may be configured to support multiple RATs. In such embodiments, some components may be duplicated (e.g., separate memory 804 for different RATs) and some components may be reused (e.g., an antenna 810 may be shared by different RATs). The network node 800 may also include multiple sets of the various illustrated components for different wireless technologies integrated into network node 800, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 800.

The processing circuitry 802 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 800 components, such as the memory 804, to provide network node 800 functionality.

In some embodiments, the processing circuitry 802 includes a System on a Chip (SOC). In some embodiments, the processing circuitry 802 includes one or more of Radio Frequency (RF) transceiver circuitry 812 and baseband processing circuitry 814. In some embodiments, the RF transceiver circuitry 812 and the baseband processing circuitry 814 may be on separate chips (or sets of chips), boards, or units, such as radio units and digital units. In alternative embodiments, part or all of the RF transceiver circuitry 812 and the baseband processing circuitry 814 may be on the same chip or set of chips, boards, or units.

The memory 804 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 802. The memory 804 may store any suitable instructions, data, or information, including a computer program, software, an application including one or more of logic, rules, code, tables, and/or other instructions capable of being executed by the processing circuitry 802 and utilized by the network node 800. The memory 804 may be used to store any calculations made by the processing circuitry 802 and/or any data received via the communication interface 806. In some embodiments, the processing circuitry 802 and the memory 804 are integrated.

The communication interface 806 is used in wired or wireless communication of signaling and/or data between a network node, access network, and/or UE. As illustrated, the communication interface 806 comprises port(s)/terminal(s) 816 to send and receive data, for example to and from a network over a wired connection. The communication interface 806 also includes radio front-end circuitry 818 that may be coupled to, or in certain embodiments a part of, the antenna 810. The radio front-end circuitry 818 comprises filters 820 and amplifiers 822. The radio front-end circuitry 818 may be connected to the antenna 810 and the processing circuitry 802. The radio front-end circuitry 818 may be configured to condition signals communicated between the antenna 810 and the processing circuitry 802. The radio front-end circuitry 818 may receive digital data that is to be sent out to other network nodes or UEs via a wireless connection. The radio front-end circuitry 818 may convert the digital data into a radio signal having the appropriate channel and bandwidth parameters using a combination of the filters 820 and/or the amplifiers 822. The radio signal may then be transmitted via the antenna 810. Similarly, when receiving data, the antenna 810 may collect radio signals which are then converted into digital data by the radio front-end circuitry 818. The digital data may be passed to the processing circuitry 802. In other embodiments, the communication interface 806 may comprise different components and/or different combinations of components.

In certain alternative embodiments, the network node 800 does not include separate radio front-end circuitry 818; instead, the processing circuitry 802 includes radio front-end circuitry and is connected to the antenna 810. Similarly, in some embodiments, all or some of the RF transceiver circuitry 812 is part of the communication interface 806. In still other embodiments, the communication interface 806 includes the one or more ports or terminals 816, the radio front-end circuitry 818, and the RF transceiver circuitry 812 as part of a radio unit (not shown), and the communication interface 806 communicates with the baseband processing circuitry 814, which is part of a digital unit (not shown).

The antenna 810 may include one or more antennas, or antenna arrays, configured to send and/or receive wireless signals. The antenna 810 may be coupled to the radio front-end circuitry 818 and may be any type of antenna capable of transmitting and receiving data and/or signals wirelessly. In certain embodiments, the antenna 810 is separate from the network node 800 and connectable to the network node 800 through an interface or port.

The antenna 810, the communication interface 806, and/or the processing circuitry 802 may be configured to perform any receiving operations and/or certain obtaining operations described herein as being performed by the network node 800. Any information, data, and/or signals may be received from a UE, another network node, and/or any other network equipment. Similarly, the antenna 810, the communication interface 806, and/or the processing circuitry 802 may be configured to perform any transmitting operations described herein as being performed by the network node 800. Any information, data, and/or signals may be transmitted to a UE, another network node, and/or any other network equipment.

The power source 808 provides power to the various components of the network node 800 in a form suitable for the respective components (e.g., at a voltage and current level needed for each respective component). The power source 808 may further comprise, or be coupled to, power management circuitry to supply the components of the network node 800 with power for performing the functionality described herein. For example, the network node 800 may be connectable to an external power source (e.g., the power grid or an electricity outlet) via input circuitry or an interface such as an electrical cable, whereby the external power source supplies power to power circuitry of the power source 808. As a further example, the power source 808 may comprise a source of power in the form of a battery or battery pack which is connected to, or integrated in, power circuitry. The battery may provide backup power should the external power source fail.

Embodiments of the network node 800 may include additional components beyond those shown in FIG. 8 for providing certain aspects of the network node's functionality, including any of the functionality described herein and/or any functionality necessary to support the subject matter described herein. For example, the network node 800 may include user interface equipment to allow input of information into the network node 800 and to allow output of information from the network node 800. This may allow a user to perform diagnostic, maintenance, repair, and other administrative functions for the network node 800.

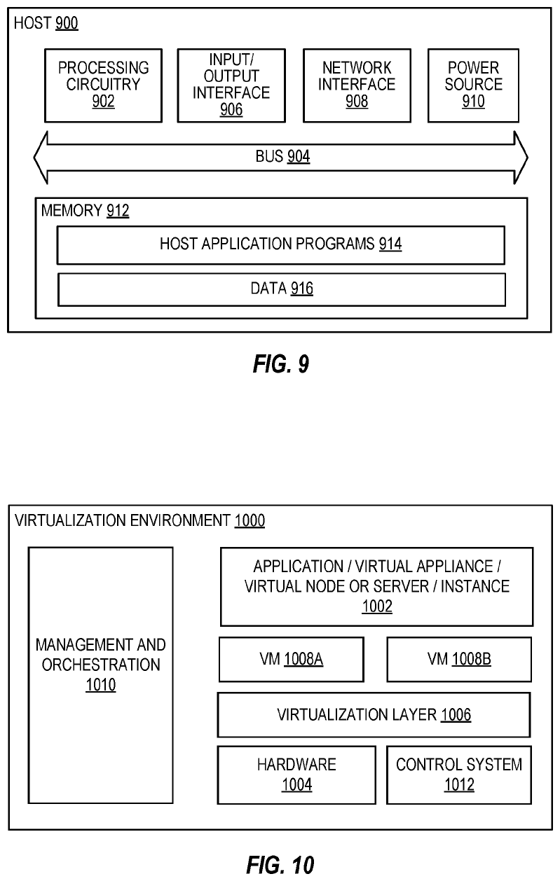

FIG. 9 is a block diagram of a host 900, which may be an embodiment of the host 616 of FIG. 6, in accordance with various aspects described herein. As used herein, the host 900 may be or comprise various combinations of hardware and/or software including a standalone server, a blade server, a cloud-implemented server, a distributed server, a virtual machine, container, or processing resources in a server farm. The host 900 may provide one or more services to one or more UEs.

The host 900 includes processing circuitry 902 that is operatively coupled via a bus 904 to an input/output interface 906, a network interface 908, a power source 910, and memory 912. Other components may be included in other embodiments. Features of these components may be substantially similar to those described with respect to the devices of previous figures, such as FIGS. 7 and 8, such that the descriptions thereof are generally applicable to the corresponding components of the host 900.

The memory 912 may include one or more computer programs including one or more host application programs 914 and data 916, which may include user data, e.g., data generated by a UE for the host 900 or data generated by the host 900 for a UE. Embodiments of the host 900 may utilize only a subset or all of the components shown. The host application programs 914 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 914 may also provide for user authentication and licensing checks and may periodically report health, routes, and content availability to a central node, such as a device in or on the edge of a core network. Accordingly, the host 900 may select and/or indicate a different host for Over-The-Top (OTT) services for a UE. The host application programs 914 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 10 is a block diagram illustrating a virtualization environment 1000 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1002 (which may alternatively be called software instances, virtual appliances, network functions, virtual nodes, virtual network functions, etc.) are run in the virtualization environment 1000 to implement some of the features, functions, and/or benefits of some of the embodiments disclosed herein.

Hardware 1004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1006 (also referred to as hypervisors or VM Monitors (VMMs)), provide VMs 1008A and 1008B (one or more of which may be generally referred to as VMs 1008), and/or perform any of the functions, features, and/or benefits described in relation with some embodiments described herein. The virtualization layer 1006 may present a virtual operating platform that appears like networking hardware to the VMs 1008.

The VMs 1008 comprise virtual processing, virtual memory, virtual networking, or interface and virtual storage, and may be run by a corresponding virtualization layer 1006. Different embodiments of the instance of a virtual appliance 1002 may be implemented on one or more of the VMs 1008, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1008 may be a software implementation of a physical machine that runs programs as if they were executing on a physical, non-virtualized machine. Each of the VMs 1008, and that part of the hardware 1004 that executes that VM, be it hardware dedicated to that VM and/or hardware shared by that VM with others of the VMs 1008, forms separate virtual network elements. Still in the context of NFV, a virtual network function is responsible for handling specific network functions that run in one or more VMs 1008 on top of the hardware 1004 and corresponds to the application 1002.

The hardware 1004 may be implemented in a standalone network node with generic or specific components. The hardware 1004 may implement some functions via virtualization. Alternatively, the hardware 1004 may be part of a larger cluster of hardware (e.g., such as in a data center or CPE) where many hardware nodes work together and are managed via management and orchestration 1010, which, among others, oversees lifecycle management of the applications 1002. In some embodiments, the hardware 1004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 1012 which may alternatively be used for communication between hardware nodes and radio units.

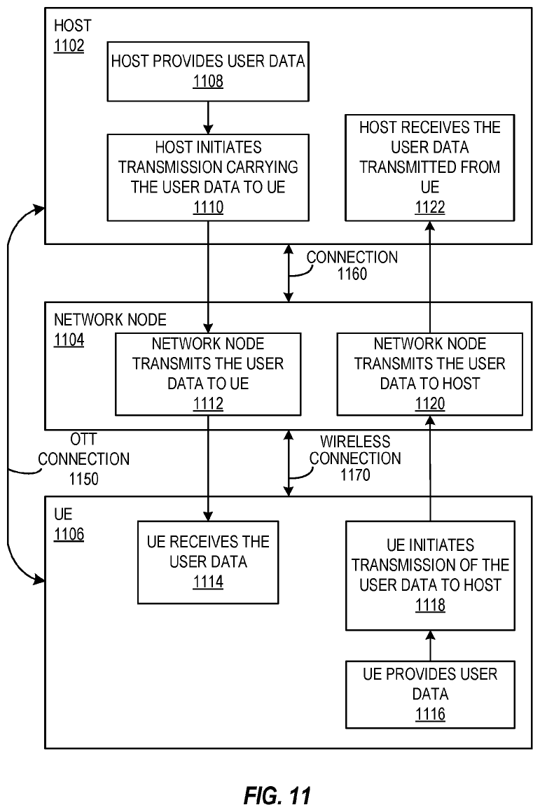

FIG. 11 shows a communication diagram of a host 1102 communicating via a network node 1104 with a UE 1106 over a partially wireless connection in accordance with some embodiments. Example implementations, in accordance with various embodiments, of the UE (such as the UE 612A of FIG. 6 and/or the UE 700 of FIG. 7), the network node (such as the network node 610A of FIG. 6 and/or the network node 800 of FIG. 8), and the host (such as the host 616 of FIG. 6 and/or the host 900 of FIG. 9) discussed in the preceding paragraphs will now be described with reference to FIG. 11.

Like the host 900, embodiments of the host 1102 include hardware, such as a communication interface, processing circuitry, and memory. The host 1102 also includes software, which is stored in or is accessible by the host 1102 and executable by the processing circuitry. The software includes a host application that may be operable to provide a service to a remote user, such as the UE 1106 connecting via an OTT connection 1150 extending between the UE 1106 and the host 1102. In providing the service to the remote user, a host application may provide user data which is transmitted using the OTT connection 1150.

The network node 1104 includes hardware enabling it to communicate with the host 1102 and the UE 1106 via a connection 1160. The connection 1160 may be direct or pass through a core network (like the core network 606 of FIG. 6) and/or one or more other intermediate networks, such as one or more public, private, or hosted networks. For example, an intermediate network may be a backbone network or the Internet.

The UE 1106 includes hardware and software, which is stored in or accessible by the UE 1106 and executable by the UE's processing circuitry. The software includes a client application, such as a web browser or operator-specific “app” that may be operable to provide a service to a human or non-human user via the UE 1106 with the support of the host 1102. In the host 1102, an executing host application may communicate with the executing client application via the OTT connection 1150 terminating at the UE 1106 and the host 1102. In providing the service to the user, the UE's client application may receive request data from the host's host application and provide user data in response to the request data. The OTT connection 1150 may transfer both the request data and the user data. The UE's client application may interact with the user to generate the user data that it provides to the host application through the OTT connection 1150.

The OTT connection 1150 may extend via the connection 1160 between the host 1102 and the network node 1104 and via a wireless connection 1170 between the network node 1104 and the UE 1106 to provide the connection between the host 1102 and the UE 1106. The connection 1160 and the wireless connection 1170, over which the OTT connection 1150 may be provided, have been drawn abstractly to illustrate the communication between the host 1102 and the UE 1106 via the network node 1104, without explicit reference to any intermediary devices and the precise routing of messages via these devices.

As an example of transmitting data via the OTT connection 1150, in step 1108, the host 1102 provides user data, which may be performed by executing a host application. In some embodiments, the user data is associated with a particular human user interacting with the UE 1106. In other embodiments, the user data is associated with a UE 1106 that shares data with the host 1102 without explicit human interaction. In step 1110, the host 1102 initiates a transmission carrying the user data towards the UE 1106. The host 1102 may initiate the transmission responsive to a request transmitted by the UE 1106. The request may be caused by human interaction with the UE 1106 or by operation of the client application executing on the UE 1106. The transmission may pass via the network node 1104 in accordance with the teachings of the embodiments described throughout this disclosure. Accordingly, in step 1112, the network node 1104 transmits to the UE 1106 the user data that was carried in the transmission that the host 1102 initiated, in accordance with the teachings of the embodiments described throughout this disclosure. In step 1114, the UE 1106 receives the user data carried in the transmission, which may be performed by a client application executed on the UE 1106 associated with the host application executed by the host 1102.

In some examples, the UE 1106 executes a client application which provides user data to the host 1102. The user data may be provided in reaction or response to the data received from the host 1102. Accordingly, in step 1116, the UE 1106 may provide user data, which may be performed by executing the client application. In providing the user data, the client application may further consider user input received from the user via an input/output interface of the UE 1106. Regardless of the specific manner in which the user data was provided, the UE 1106 initiates, in step 1118, transmission of the user data towards the host 1102 via the network node 1104. In step 1120, in accordance with the teachings of the embodiments described throughout this disclosure, the network node 1104 receives user data from the UE 1106 and initiates transmission of the received user data towards the host 1102. In step 1122, the host 1102 receives the user data carried in the transmission initiated by the UE 1106.

One or more of the various embodiments improve the performance of OTT services provided to the UE 1106 using the OTT connection 1150, in which the wireless connection 1170 forms the last segment. More precisely, the teachings of these embodiments may improve the e.g., data rate, latency, power consumption, etc. and thereby provide benefits such as e.g., reduced user waiting time, relaxed restriction on file size, improved content resolution, better responsiveness, extended battery lifetime, etc.

In an example scenario, factory status information may be collected and analyzed by the host 1102. As another example, the host 1102 may process audio and video data which may have been retrieved from a UE for use in creating maps. As another example, the host 1102 may collect and analyze real-time data to assist in controlling vehicle congestion (e.g., controlling traffic lights). As another example, the host 1102 may store surveillance video uploaded by a UE. As another example, the host 1102 may store or control access to media content such as video, audio, VR, or AR which it can broadcast, multicast, or unicast to UEs. As other examples, the host 1102 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1150 between the host 1102 and the UE 1106 in response to variations in the measurement results. The measurement procedure and/or the network functionality for reconfiguring the OTT connection 1150 may be implemented in software and hardware of the host 1102 and/or the UE 1106. In some embodiments, sensors (not shown) may be deployed in or in association with other devices through which the OTT connection 1150 passes; the sensors may participate in the measurement procedure by supplying values of the monitored quantities exemplified above, or by supplying values of other physical quantities from which software may compute or estimate the monitored quantities. The reconfiguring of the OTT connection 1150 may include message format, retransmission settings, preferred routing, etc.; the reconfiguring need not directly alter the operation of the network node 1104. Such procedures and functionalities may be known and practiced in the art. In certain embodiments, measurements may involve proprietary UE signaling that facilitates measurements of throughput, propagation times, latency, and the like by the host 1102. The measurements may be implemented in that software causes messages to be transmitted, in particular empty or ‘dummy’ messages, using the OTT connection 1150 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

### EMBODIMENTS

### Group A Embodiments

Embodiment 1: A method performed by a user equipment, the method comprising one or more of: receiving (300) a configuration with a bidirectional timing measurement (e.g., UE Rx-Tx time difference) on one or more cells; adapting (302) the bidirectional timing measurement procedure based on one or more conditions or relations or criteria; and using (304) the adapted procedure for performing the configured bidirectional timing measurement.

Embodiment 2: The method of embodiment 1 wherein the conditions or relations or criteria triggering the measurement adaption comprise one or more of: whether or not, both UL RS (e.g., SRS) and DL RS (e.g., PRS) configured for performing the bidirectional timing measurement operate (e.g., transmit and/or receive) in a UE's DL reference cell; and whether the uplink transmission timing changes during the bidirectional timing measurement period due to UE autonomous timing adjustment.

Embodiment 3: The method of any of embodiments 1-2 wherein, if both UL RS (e.g., SRS) and DL RS (e.g., PRS) configured for performing the bidirectional timing measurement operate in the UE's DL reference cell, then the UE performs or continues performing the bidirectional timing measurement regardless of whether the UE's uplink transmission timing changes during the bidirectional timing measurement period due to the UE autonomous timing adjustment.

Embodiment 4: The method of any of embodiments 1-3 wherein, if both UL RS (e.g., SRS) and DL RS (e.g., PRS) configured for performing the bidirectional timing measurement do not operate in the UE's DL reference cell, then whether the UE performs or continues performing the bidirectional timing measurement depends on whether the UE's uplink transmission timing changes during the bidirectional timing measurement period due to the UE autonomous timing adjustment.

Embodiment 5: The method of any of embodiments 1-4 wherein, if the uplink transmission timing changes during the bidirectional timing measurement period due to UE autonomous timing adjustment, discarding, stopping, abandoning, or postponing the bidirectional timing measurement.

Embodiment 6: The method of any of embodiments 1-5 further comprising, discarding, stopping, abandoning, or postponing the bidirectional timing measurement (e.g., UE Rx-Tx time difference measurement) being performed or configured to be performed in a cell in which the SRS is not configured if the uplink transmission timing changes during the bidirectional timing measurement period (e.g., UE Rx-Tx time difference measurement period) due to UE autonomous timing adjustment.

Embodiment 7: The method of any of embodiments 1-6 wherein, if the uplink transmission timing does not during the bidirectional timing measurement period due to UE autonomous timing adjustment, then performing or continuing performing the bidirectional timing measurement in the cell in which the SRS is not configured.

Embodiment 8: The method of any of embodiments 1-7 further comprising performing or continuing performing the bidirectional timing measurement (e.g., UE Rx-Tx time difference measurement) in a cell in which the SRS is configured regardless of whether the uplink transmission timing changes during the bidirectional timing measurement period (e.g., UE Rx-Tx time difference measurement period) due to UE autonomous timing adjustment.

Embodiment 9: The method of any of embodiments 1-8 wherein the bidirectional timing measurement requirement (e.g., UE Rx-Tx time difference measurement accuracy requirements) for the bidirectional timing measurement performed in a cell in which the SRS is not configured shall not apply if the uplink transmission timing changes during the UE Rx-Tx time difference measurement period due to UE autonomous timing adjustment.

Embodiment 10: The method of any of embodiments 1-9 wherein bidirectional timing measurement requirement (e.g., UE Rx-Tx time difference measurement accuracy requirements) for the bidirectional timing measurement performed in a cell in which the SRS is configured shall apply regardless of whether the uplink transmission timing changes during the UE Rx-Tx time difference measurement period due to UE autonomous timing adjustment.

Embodiment 11: The method of any of the previous embodiments, further comprising: providing user data; and forwarding the user data to a host via the transmission to the network node.

### Group B Embodiments

Embodiment 12: A method performed by a network node, the method comprising one or more of: being (400) configured with a bidirectional timing measurement (e.g., gNB Rx-Tx time difference) on one or more cells; adapting (402) the bidirectional timing measurement procedure based on one or more conditions or relations or criteria; and using (404) the adapted procedure for performing the configured bidirectional timing measurement.

Embodiment 13: The method of embodiment 12 wherein the conditions or relations or criteria triggering the measurement adaption comprise one or more of: whether or not, both UL RS (e.g., SRS) and DL RS (e.g., PRS) configured for performing the bidirectional timing measurement operate (e.g., transmit and/or receive); and whether the uplink transmission timing changes during the bidirectional timing measurement period due to UE autonomous timing adjustment.

Embodiment 14: The method of any of embodiments 12-13 wherein, if both UL RS (e.g., SRS) and DL RS (e.g., PRS) configured for performing the bidirectional timing measurement, then performing or continuing performing the bidirectional timing measurement regardless of whether the network node's or UE's uplink transmission timing changes during the bidirectional timing measurement period due to the UE autonomous timing adjustment.

Embodiment 15: The method of any of embodiments 12-14 wherein, if both UL RS (e.g., SRS) and DL RS (e.g., PRS) configured for performing the bidirectional timing measurement do not operate in the UE's DL reference cell, then whether the network node or UE performs or continues performing the bidirectional timing measurement depends on whether the network node's or UE's uplink transmission timing changes during the bidirectional timing measurement period due to the network node or UE autonomous timing adjustment.

Embodiment 16: The method of any of embodiments 12-15 wherein, if the uplink transmission timing changes during the bidirectional timing measurement period due to network node or UE autonomous timing adjustment, discarding, stopping, abandoning, or postponing the bidirectional timing measurement.

Embodiment 17: The method of any of embodiments 12-16 further comprising, discarding, stopping, abandoning, or postponing the bidirectional timing measurement (e.g., UE Rx-Tx time difference measurement) being performed or configured to be performed in a cell in which the SRS is not configured if the uplink transmission timing changes during the bidirectional timing measurement period (e.g., UE Rx-Tx time difference measurement period) due to network node or UE autonomous timing adjustment.

Embodiment 18: The method of any of embodiments 12-17 wherein, if the uplink transmission timing does not during the bidirectional timing measurement period due to network node or UE autonomous timing adjustment, then performing or continuing performing the bidirectional timing measurement in the cell in which the SRS is not configured.

Embodiment 19: The method of any of embodiments 12-18 further comprising performing or continuing performing the bidirectional timing measurement (e.g., UE Rx-Tx time difference measurement) in a cell in which the SRS is configured regardless of whether the uplink transmission timing changes during the bidirectional timing measurement period (e.g., UE Rx-Tx time difference measurement period) due to network node or UE autonomous timing adjustment.

Embodiment 20: The method of any of embodiments 12-19 wherein the bidirectional timing measurement requirement (e.g., UE Rx-Tx time difference measurement accuracy requirements) for the bidirectional timing measurement performed in a cell in which the SRS is not configured shall not apply if the uplink transmission timing changes during the UE Rx-Tx time difference measurement period due to network node or UE autonomous timing adjustment.

Embodiment 21: The method of any of embodiments 12-20 wherein bidirectional timing measurement requirement (e.g., UE Rx-Tx time difference measurement accuracy requirements) for the bidirectional timing measurement performed in a cell in which the SRS is configured shall apply regardless of whether the uplink transmission timing changes during the UE Rx-Tx time difference measurement period due to network node or UE autonomous timing adjustment.

Embodiment 22: The method of any of the previous embodiments, further comprising: obtaining user data; and forwarding the user data to a host or a user equipment. Group C Embodiments

Embodiment 23: A user equipment, comprising: processing circuitry configured to perform any of the steps of any of the Group A embodiments; and power supply circuitry configured to supply power to the processing circuitry.

Embodiment 24: A network node, the network node comprising: processing circuitry configured to perform any of the steps of any of the Group B embodiments; power supply circuitry configured to supply power to the processing circuitry.

Embodiment 25: A user equipment (UE), the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 26: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to receive the user data from the host.

Embodiment 27: The host of the previous embodiment, wherein the cellular network further includes a network node configured to communicate with the UE to transmit the user data to the UE from the host.

Embodiment 28: The host of the previous 2 embodiments, wherein: the processing circuitry of the host is configured to execute a host application, thereby providing the user data; and the host application is configured to interact with a client application executing on the UE, the client application being associated with the host application.

Embodiment 29: A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Embodiment 30: The method of the previous embodiment, further comprising: at the host, executing a host application associated with a client application executing on the UE to receive the user data from the UE.

Embodiment 31: The method of the previous embodiment, further comprising: at the host, transmitting input data to the client application executing on the UE, the input data being provided by executing the host application, wherein the user data is provided by the client application in response to the input data from the host application.

Embodiment 32: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.

Embodiment 33: The host of the previous embodiment, wherein the cellular network further includes a network node configured to communicate with the UE to transmit the user data from the UE to the host.

Embodiment 34: The host of the previous 2 embodiments, wherein: the processing circuitry of the host is configured to execute a host application, thereby providing the user data; and the host application is configured to interact with a client application executing on the UE, the client application being associated with the host application.

Embodiment 35: A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.

Embodiment 36: The method of the previous embodiment, further comprising: at the host, executing a host application associated with a client application executing on the UE to receive the user data from the UE.

Embodiment 37: The method of the previous embodiment, further comprising: at the host, transmitting input data to the client application executing on the UE, the input data being provided by executing the host application, wherein the user data is provided by the client application in response to the input data from the host application.

Embodiment 38: A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

Embodiment 39: The host of the previous embodiment, wherein: the processing circuitry of the host is configured to execute a host application that provides the user data; and the UE comprises processing circuitry configured to execute a client application associated with the host application to receive the transmission of user data from the host.

Embodiment 40: A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B embodiments to transmit the user data from the host to the UE.

Embodiment 41: The method of the previous embodiment, further comprising, at the network node, transmitting the user data provided by the host for the UE.

Embodiment 42: The method of any of the previous 2 embodiments, wherein the user data is provided at the host by executing a host application that interacts with a client application executing on the UE, the client application being associated with the host application.

Embodiment 43: A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

Embodiment 44: The communication system of the previous embodiment, further comprising: the network node; and/or the user equipment.

Embodiment 45: A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

Embodiment 46: The host of the previous 2 embodiments, wherein: the processing circuitry of the host is configured to execute a host application, thereby providing the user data; and the host application is configured to interact with a client application executing on the UE, the client application being associated with the host application.

Embodiment 47: The host of the any of the previous 2 embodiments, wherein the initiating receipt of the user data comprises requesting the user data.

Embodiment 48: A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.

Embodiment 49: The method of the previous embodiment, further comprising at the network node, transmitting the received user data to the host.

Those skilled in the art will recognize improvements and modifications to the embodiments of the present disclosure. All such improvements and modifications are considered within the scope of the concepts disclosed herein.

1. A method performed by a User Equipment, UE, for bidirectional timing measurement, the method comprising:
receiving a configuration for performing a bidirectional timing measurement on one or more cells;
adapting a bidirectional timing measurement procedure based on one or more conditions or relations or criteria; and
using the adapted procedure for performing the configured bidirectional timing measurement;
where the conditions or relations or criteria triggering the measurement adaption comprise: whether the one or more cells for the bidirectional timing measurement is a Downlink, DL, reference cell for an Uplink, UL, Reference Signal, RS, transmission for the UE.

2. The method of claim 1 wherein the configured bidirectional timing measurement comprises one or more of:
a UE Receive-Transmit, Rx-Tx, time difference;
a round trip time for propagation delay compensation; and
a timing advance.

3. The method of claim 1 wherein the conditions or relations or criteria triggering the measurement adaption comprise: whether the one or more cells for the bidirectional timing measurement is a Downlink, DL, reference cell for an Uplink, UL, Sounding Reference Signal, SRS, transmission for the UE.

4. The method of claim 1 wherein the conditions or relations or criteria triggering the measurement adaption comprise one or more of:
whether or not, both an Uplink, UL, Reference Signal, RS, and the DL RS configured for performing the bidirectional timing measurement operate in a UE's DL reference cell; and
whether uplink transmission timing changes during a bidirectional timing measurement period due to a UE autonomous timing adjustment.

5. The method of claim 1 wherein, if both the UL RS and the DL RS configured for performing the bidirectional timing measurement operate in the UE's DL reference cell, then the UE performs or continues performing the bidirectional timing measurement regardless of whether the UE's uplink transmission timing changes during the bidirectional timing measurement period due to the UE autonomous timing adjustment.

6. The method of claim 1 wherein, if both the UL RS and the DL RS configured for performing the bidirectional timing measurement do not operate in the UE's DL reference cell, then whether the UE performs or continues performing the bidirectional timing measurement depends on whether the UE's uplink transmission timing changes during the bidirectional timing measurement period due to the UE autonomous timing adjustment.

7. The method of claim 4 wherein the UL RS comprises the SRS and the DL RS comprises at least one of: a Positioning Reference Signal, PRS; Channel State Information-Reference Signal, CSI-RS; and Synchronization signal and PBCH block, SSB.

8. The method of claim 1 wherein, if the uplink transmission timing changes during the bidirectional timing measurement period due to the UE autonomous timing adjustment, discarding, stopping, abandoning, postponing, or restarting the bidirectional timing measurement.

9. The method of claim 1 further comprising, discarding, stopping, abandoning, postponing, or restarting the bidirectional timing measurement being performed or configured to be performed in a cell in which the SRS is not configured if the uplink transmission timing changes during the bidirectional timing measurement period due to the UE autonomous timing adjustment.

10. The method of claim 1 further comprising performing or continuing performing the bidirectional timing measurement in a cell in which the SRS is configured regardless of whether the uplink transmission timing changes during the bidirectional timing measurement period due to the UE autonomous timing adjustment.

11. The method of claim 1 wherein a bidirectional timing measurement requirement for the bidirectional timing measurement performed in a cell in which the SRS is not configured shall not apply if the uplink transmission timing changes during a UE Rx-Tx time difference measurement period due to the UE autonomous timing adjustment.

12. The method of claim 1 wherein the bidirectional timing measurement requirement for the bidirectional timing measurement performed in a cell in which the SRS is configured shall apply regardless of whether the uplink transmission timing changes during the UE Rx-Tx time difference measurement period due to the UE autonomous timing adjustment.

13. The method of claim 1 wherein if the uplink transmission timing changes during the bidirectional timing measurement period due to the UE autonomous timing adjustment, the measurement is restarted.

14. A method performed by a network node for bidirectional timing measurement, the method comprising:
configuring a User Equipment, UE, for performing a bidirectional timing measurement on one or more cells;
receiving one or more bidirectional timing measurements;
where a bidirectional timing measurement procedure was adapted based on one or more conditions or relations or criteria;
where the conditions or relations or criteria triggering the measurement adaption comprise: whether the one or more cells for the bidirectional timing measurement is a Downlink, DL, reference cell for an Uplink, UL, Reference Signal, RS, transmission for the UE.

15. The method of claim 14 wherein the bidirectional timing measurement comprises one or more of:
a UE Receive-Transmit, Rx-Tx, time difference;
a round trip time for propagation delay compensation; and
a timing advance.

16. The method of claim 14 wherein the conditions or relations or criteria triggering the measurement adaption comprise: whether the one or more cells for the bidirectional timing measurement is a Downlink, DL, reference cell for a Sounding Reference Signal, SRS, transmission for the UE.

17. The method of claim 14 wherein the conditions or relations or criteria triggering the measurement adaption comprise one or more of:
whether or not both an Uplink, UL, Reference Signal, RS, and the DL RS configured for performing the bidirectional timing measurement operate in a UE's DL reference cell; and
whether uplink transmission timing changes during a bidirectional timing measurement period due to a UE autonomous timing adjustment.

18. The method of claim 14 wherein, if both the UL RS and the DL RS configured for performing the bidirectional timing measurement operate in the UE's DL reference cell, then the UE performs or continues performing the bidirectional timing measurement regardless of whether the UE's uplink transmission timing changes during the bidirectional timing measurement period due to the UE autonomous timing adjustment.

19-25. (canceled)

26. A User Equipment, UE, for bidirectional timing measurement, the UE comprising:
processing circuitry; and
memory storing instructions executable by the processing circuitry, whereby the UE is operable to:
receive a configuration for performing a bidirectional timing measurement on one or more cells;
adapt a bidirectional timing measurement procedure based on one or more conditions or relations or criteria; and
use the adapted procedure for performing the configured bidirectional timing measurement;
where the conditions or relations or criteria triggering the measurement adaption comprise: whether the one or more cells for the bidirectional timing measurement is a Downlink, DL, reference cell for an Uplink, UL, Reference Signal, RS, transmission for the UE.

27. (canceled)

28. A network node for bidirectional timing measurement, the network node comprising:
processing circuitry; and
memory comprising instructions to cause the network node to perform the steps of:
configure a User Equipment, UE, for configuring a bidirectional timing measurement on one or more cells;
receive one or more bidirectional timing measurements;
where a bidirectional timing measurement procedure was adapted based on one or more conditions or relations or criteria;
where the conditions or relations or criteria triggering the measurement adaption comprise: whether the one or more cells for the bidirectional timing measurement is a Downlink, DL, reference cell for an Uplink, UL, Reference Signal, RS, transmission for the UE.

29. (canceled)
